(19) United States
(12) Patent Application Publication
(10) Pub. No.: US 2025/0214411 A1
(43) Pub. Date: Jul. 3, 2025

(54) IN-WHEEL DRIVE ASSEMBLY

(71) Applicant: Consolidated Metco, Inc., Vancouver, WA (US)

(72) Inventors: Adrianus Petrus Maria Jonker, Doorwerth (NL); Gerrit Jan Kwintenberg, Apeldoorn (NL); Yang Tang, Apeldoorn (NL); Jonathan Roy Elkin, Camas, WA (US); Jared Wiley Richard Burris, Ridgefield, WA (US); Bryan Williams, Camas, WA (US); Michael Miga, Portland, OR (US); Joseph Johann Emery, Vancouver, WA (US); Ryan John Warsen, Vancouver, WA (US); Adam D. Foltz, Indianapolis, IN (US)

(21) Appl. No.: 18/982,304

(22) Filed: Dec. 16, 2024

Related U.S. Application Data
(60) Provisional application No. 63/615,396, filed on Dec. 28, 2023.

(51) Int. Cl. B60K 7/00; B60B 27/00; B60K 11/02; B60K 17/04; B60R 16/02; F16H 1/28; F16H 57/02; F16H 57/029; F16H 57/031; F16H 57/04; H02K 1/18; H02K 1/20; H02K 7/08; H02K 7/116; H02K 11/225; H02K 11/40; H02K 21/22; H02K 24/00

(52) U.S. Cl. CPC B60K 7/0007; B60B 27/0015; B60B 27/0047; B60K 11/02; B60K 17/046; B60R 16/0207; F16H 1/28; F16H 57/029; F16H 57/031; F16H 57/0427; F16H 57/0476; F16H 57/0486; H02K 1/187; H02K 1/20; H02K 7/085; H02K 7/116; H02K 11/225; H02K 11/40; H02K 21/22; H02K 24/00; B60K 2007/0092; F16H 2057/02034; F16H 2057/02052

(57) ABSTRACT

In one aspect, an in-wheel drive assembly is provided that includes a stator configured to form a non-rotatable connection with a spindle of a vehicle and be positioned outboard of the spindle. The in-wheel drive assembly includes a stator retainer configured to extend in an interior of the spindle and inhibit movement of the stator in an outboard direction relative to the spindle. The in-wheel drive assembly further includes a rotor rotatably supported by the stator, an output housing to be connected to a wheel hub, and a planetary gear assembly operatively connecting the rotor and the output housing. The planetary gear assembly is configured to cause rotation of the output housing and wheel hub connected thereto in response to rotation of the rotor.

### CROSS-REFERENCE TO RELATED APPLICATION

This application claims the benefit of U.S. Provisional Application No. 63/615,396 filed Dec. 28, 2023, which is incorporated herein by reference in its entirety.

### TECHNICAL FIELD

This disclosure relates to drive assemblies for vehicles and, more specifically, relates to electric drive assemblies for vehicles.

### BACKGROUND

Drive assemblies are known for use in propelling vehicles. Some drive assemblies utilize electric motors individually coupled to wheels of a vehicle to provide torque to the wheels and propel the associated vehicle. The electric motors of these drive assemblies may be mounted inboard of the wheels of the vehicle. Integrating electric motors inboard of the wheels of a vehicle may not be desirable from a vehicle manufacturer perspective, since mounting electric motors inboard of the vehicle wheels may require substantial modifications to the wheel hubs, brake assemblies, suspension, and/or body of a vehicle.

### SUMMARY

In one aspect of the present disclosure, an in-wheel drive assembly is provided that includes a stator configured to form a non-rotatable connection with a spindle of a vehicle and be positioned outboard of the spindle. The in-wheel drive assembly includes a stator retainer configured to extend in an interior of the spindle and inhibit movement of the stator in an outboard direction relative to the spindle. The in-wheel drive assembly further includes a rotor rotatably supported by the stator, an output housing to be connected to a wheel hub, and a planetary gear assembly operatively connecting the rotor and the output housing. The planetary gear assembly is configured to cause rotation of the output housing and wheel hub connected thereto in response to rotation of the rotor. The stator retainer extends in the interior of the spindle rather than being secured to the exterior of the spindle, which moves the retaining structure for the stator away from the outboard end of the spindle and permits a tighter packaging of the in-wheel drive assembly within the associated wheel.

In one embodiment, the stator retainer is configured to extend in the interior of the spindle spaced from the spindle and connect to a mount of the vehicle inboard of the spindle. To remove the in-wheel drive assembly, a user disconnects the stator retainer from the mount inboard of the spindle. In this manner, the connection between the stator retainer and the vehicle mount is inboard, away from the stator and facilitates disconnecting the stator from the spindle via the inboard-or vehicle-side of the in-wheel drive assembly.

For example, the stator retainer may include an elongate member having an end portion for extending in an opening of the mount and a locking member configured to secure the elongate member to the mount with the end portion of the elongate member extending in the opening of the mount. To service the in-wheel drive assembly, a technician removes the locking member to disconnect the elongate member from the mount. The technician may then slide the stator off of the spindle in an outboard direction.

### BRIEF DESCRIPTION OF DRAWINGS

FIG. 1 is a perspective view of a wheel end supporting a wheel rim assembly and a drive assembly for rotating the rim assembly;

FIG. 2 is a cross-sectional view taken along line 2-2 in FIG. 1 showing a rotor of the drive assembly rotatably mounted to a stator sleeve secured to an outboard end of a spindle;

FIG. 3 is a cross-sectional view taken along line 3-3 in FIG. 1 showing a planetary gear assembly for transferring rotation of the rotor to an output housing fixed to the wheel hub;

FIG. 4 is a cross-sectional view similar to FIG. 2 showing a retaining rod extending through the interior of the spindle to keep the stator sleeve secured to the outboard end of the spindle;

FIG. 5 is an enlarged view of the area shown in the dashed rectangle of FIG. 4, FIG. 5 showing a spline connection between a ring gear of the planetary gear assembly and the stator sleeve and a floating spline connection between a sun gear of the planetary gear assembly and a rotor body of the rotor;

FIG. 6 is a perspective view of the drive assembly of FIG. 4 removed from the wheel hub, FIG. 6 showing a cover of the drive assembly removed to show openings in the ring gear that permit oil to flow therethrough for lubricating the planetary gear assembly;

FIG. 7 is a perspective view of the stator sleeve of FIG. 2 showing a central opening that receives a harness and radial openings of the stator sleeve that permit electrical cables and coolant tubes of the harness to be connected to coils and a cooling jacket of the stator;

FIG. 8 is a perspective view of the output housing having an outboard gear support portion for supporting planet gears of the planetary gear assembly and an inboard flange for securing to the wheel mounting flange of the wheel hub;

FIG. 9 is a cross-sectional view of the cooling jacket of the stator of the drive assembly of FIG. 4 showing an annular channel for receiving cooled coolant from the harness, directing the coolant around the cooling jacket to absorb heat from the windings of the stator, and returning the heated coolant to the harness;

FIG. 10 is a perspective view of an interior of the cover of the drive assembly of FIG. 4, FIG. 10 showing internal vanes that urge oil radially inward for redistribution to the planetary gear assembly as the cover rotates with the output housing;

FIG. 11 is a cross-sectional view of an alternative embodiment of a connection between the cover and the output housing of the drive assembly of FIG. 4, the embodiment of FIG. 11 having fasteners secure the cover to the output housing;

FIG. 12 is a perspective view of another output housing that may be utilized in the drive assembly of FIG. 1; and

FIG. 13 is a perspective view of another stator sleeve and a harness that may be utilized in the drive assembly of FIG. 1.

### DETAILED DESCRIPTION

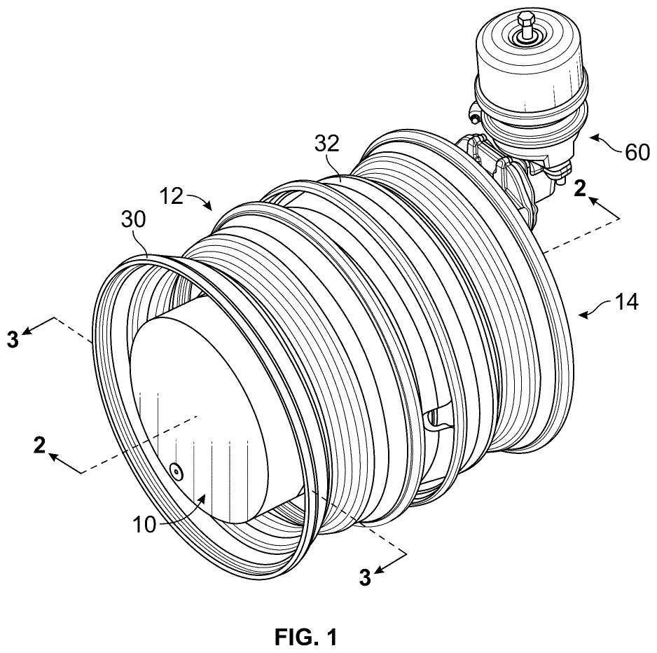

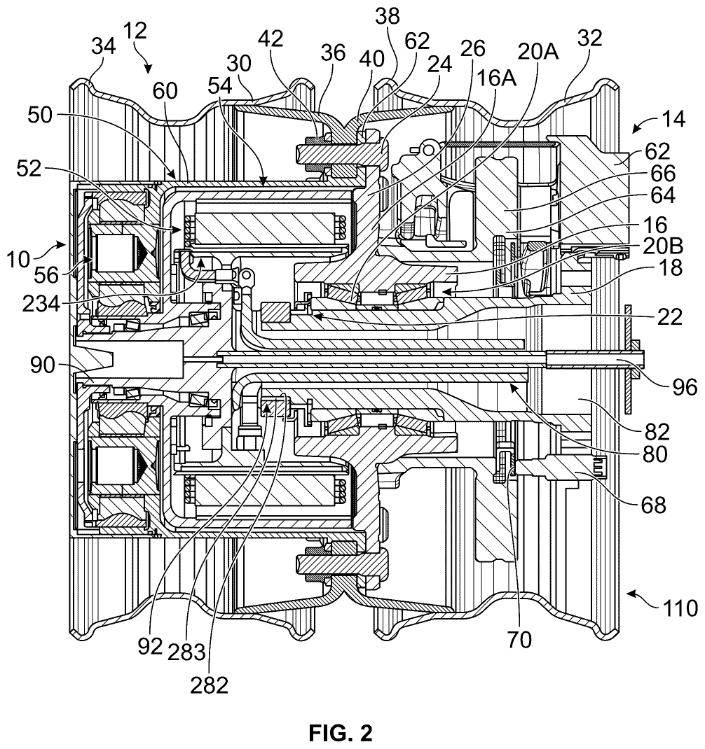

Regarding FIG. 1, a drive assembly 10 is provided for rotating a rim assembly 12 connected to a wheel end assembly 14 of a vehicle. Regarding FIG. 2, the wheel end assembly 14 includes a wheel hub 16 rotatably mounted to a spindle 18 via bearing assemblies 20A, 20B and a spindle lock nut 22. The wheel hub 16 has a wheel hub body 16A with a unitary, one-piece construction. The wheel hub body 16A includes an interior that receives the bearing assemblies 20A, 20B and a wheel hub mounting flange 26. The bearing assemblies 20A, 20B may take various forms, such as a unitary embodiment as shown in FIG. 2, an embodiment wherein the bearing assemblies 20A, 20B are separated by a spacer, or an embodiment wherein there are separate inboard and outboard bearing assemblies 20A, 20B without a spacer and the wheel hub endplay is set manually by adjusting a spindle nut of the wheel end. The wheel hub 16 includes studs 24 protruding from the wheel mounting flange 26 for receiving the rim assembly 12.

With reference to FIGS. 1 and 2, the rim assembly 12 includes an outboard rim 30 and an inboard rim 32 that each receive a tire. The outboard rim 30 and inboard rim 32 are similar and receive similar tires. The outboard rim 30 includes a rim portion 34 and an outboard flange portion 36 whereas the inboard rim 32 includes a rim portion 38 and an inboard flange portion 40. The outboard and inboard flange portions 36, 40 have openings that are configured to be aligned and fit onto the studs 24 of the wheel hub 16 to connect the rim assembly 12 to the wheel hub 16. Nuts 42 secure the rim portions 34, 38 of the rim assembly 12 to the wheel hub 16.

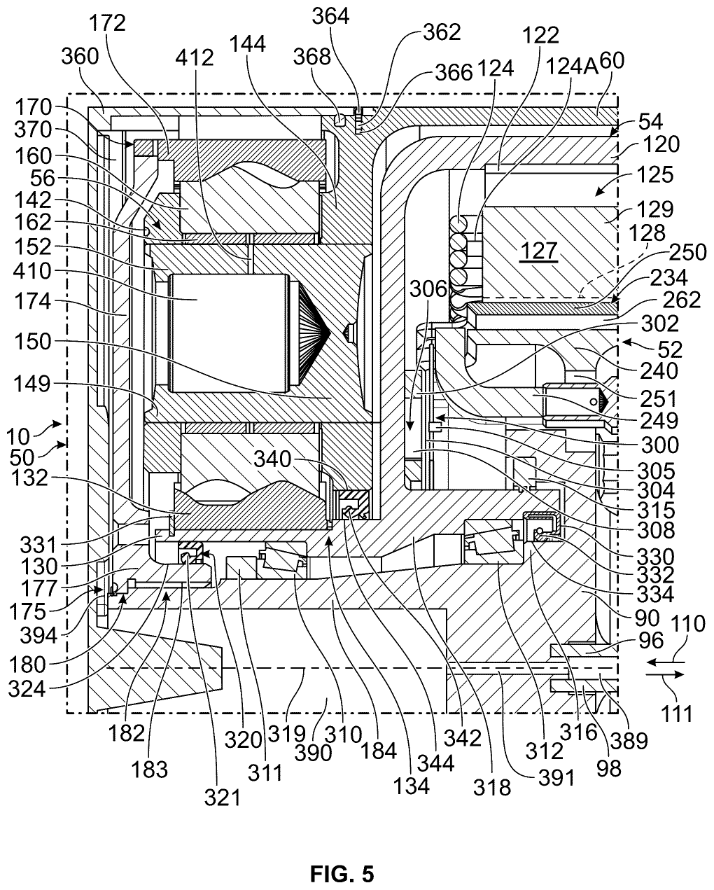

The drive assembly 10 includes a motor 50 having a stator 52 and a rotor 54. The motor 50 may have a variable frequency drive. The motor 50 may be a permanent magnet synchronous machine. The stator 52 includes laminations of steel to reduce eddy current losses in the stator 52. The stator 52 includes one or more temperature sensors 124A (see FIG. 5) to detect overheating of coils 124 of the stator 52.

The drive assembly 10 includes a transmission or gearbox, such as a planetary gear assembly 56, configured to transfer rotation of the rotor 54 at a first speed to rotation of a drive body such as an output housing 60 at a different speed. In one embodiment, the planetary gear assembly 56 causes the output housing 60 to rotate at a slower speed than the rotor 54 to provide increased torque to the wheel hub 16. For example, the planetary gear assembly 56 may have a gear ratio of 3.802 such that the rotor 54 rotates at roughly 3.8 times the speed of the output housing 60.

Regarding FIG. 2, the output housing 60 has a flange 62 positioned between the inboard flange portion 40 and the wheel mounting flange 26. The nuts 42 clamp the outboard and inboard flange portions 36, 40 of the rim assembly 12 and the flange 62 of the output housing 60 between the nuts 42 and the wheel mounting flange 26. In this manner, upon rotation of the rotor 54 at a first speed, the planetary gear assembly 56 causes rotation of the output housing 60 and wheel hub 16 and rim assembly 12 secured thereto at a slower, second speed which propels the vehicle. The vehicle may be, for example, a bus, a tractor of a semi-truck, a trailer of a semi-truck, or a straight truck.

Regarding FIGS. 1 and 2, the wheel end assembly 14 includes a brake system such as a disc brake system 60 having a caliper assembly 62 to selectively engage a disc portion 64 of a brake rotor 66 secured to the wheel hub 16. In FIG. 2, the brake rotor 66 is a U-type brake rotor although other rotors may be used. Still further, in another embodiment the wheel end assembly 14 may utilize a drum brake. The motor 50 is outboard of the wheel hub 16 such that a conventional brake disc brake system may be utilized with the wheel hub 16 without the brake system being reconfigured to accommodate the motor 50. The wheel end assembly 14 may include an ABS tone ring mounted to an inboard surface of the wheel hub 16 and an ABS sensor to interact with the ABS tone ring.

Regarding FIG. 2, the wheel end assembly 14 includes a speed sensor 68 for a tachograph of the vehicle and a pole wheel 70 mounted to, or otherwise associated with, the brake rotor 66.

The drive assembly 10 includes one or more conduits, such as an harness 80, that extends in an interior 82 of the spindle 18. The harness 80 of FIG. 2 facilitates an electrical connection between the motor 50 and a control system on-board the vehicle via electrical conduits of the harness 80. Further, the harness 80 facilitates a fluid connection between a cooling jacket 234 of the stator 52 and a coolant system on-board the vehicle. In this manner, the harness 80 facilitates the provision of electrical power and coolant to the motor 50 while the rotor 54, output housing 60, rim assembly 12, and wheel hub 16 rotate during movement of the vehicle. The harness 80 further includes a separate data connection for a position sensor 300 (see FIG. 5) of the motor 50, one or more temperature sensors, and a cable for a ground connection.

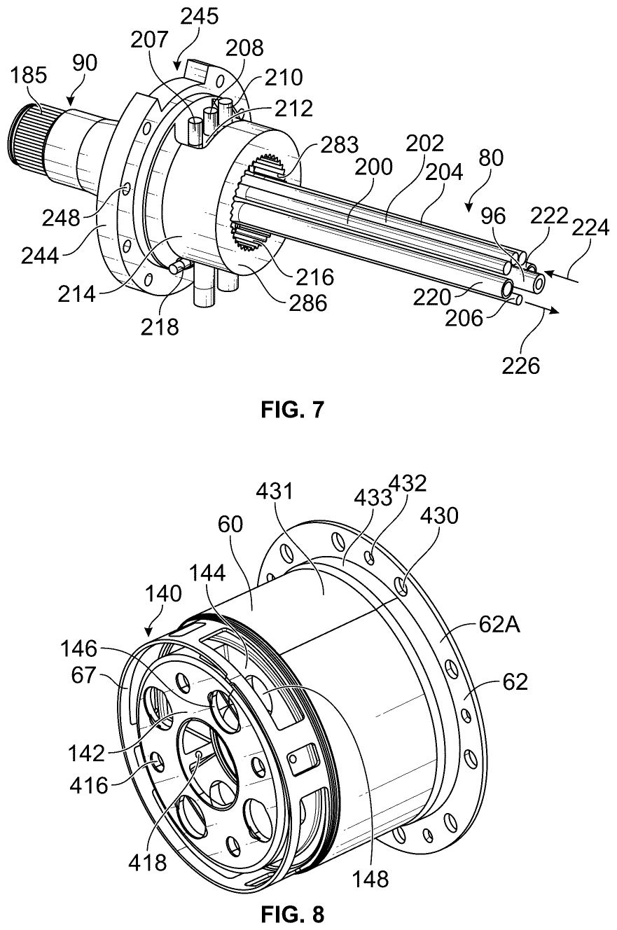

Regarding FIG. 2, the stator 52 includes a stator mount, such as a stator sleeve 90, that is mounted to the spindle 18 via a non-rotatable connection 92 which, in one embodiment, comprises engaged splines 282 of the spindle 18 and splines 283 (see also FIG. 7) of the stator sleeve 90. The non-rotatable connection 92 operates as a slide connection and permits the stator sleeve 90 to be slid onto and connected with the spindle 18 by advancing the stator sleeve 90 in an inboard direction 111 (see FIG. 5). The non-rotatable connection 92 resists turning of the motor 50 as the motor 50 applies torque to the wheel hub 16 via the planetary gear assembly 56. Alternatively or additionally, the non-rotatable connection 92 may include an engaged key and keyway.

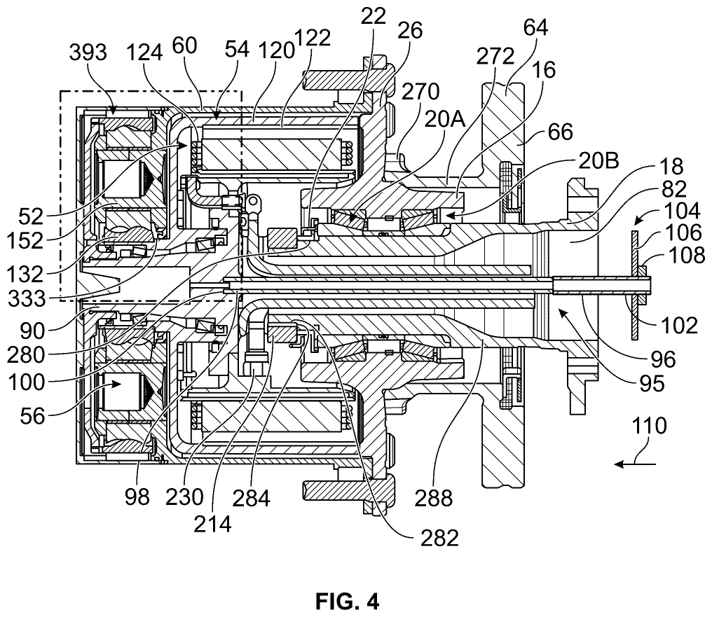

Regarding FIG. 4, the stator 52 includes a retainer 95 connecting the stator sleeve 90 to a mount 104 of the vehicle. The retainer 95 keeps the stator sleeve 90 from shifting in an outboard direction 110. Because the retainer 95 inhibits movement of the outboard direction 110, the splines 282, 283 (see FIG. 7) of the spindle 18 and stator sleeve 90 remain engaged and inhibit turning of the stator sleeve 90 relative to the spindle 18.

In one embodiment, the retainer 95 includes a rod 96 having opposite end portions 98, 102. The end portion 98 of the rod 96 is configured to connect to, or may be integral with, the stator sleeve 90. The end portion 102 is configured to connect to the mount 104. As one example, the end portion 98 may have male threads that engage female threads of a bore 100 and the end portion 102 is sized to extend through an opening of a plate 106 of the mount 104. A jam nut may be provided on the end portion 98 of the rod 96 to lock the rod 96 in engagement with the stator sleeve 90. In another approach, the stator sleeve 90 has a step to lock the rod 96 to the stator sleeve 90.

The retainer 95 may include a nut 108 with female threads to engage male threads of the end portion 102 of the rod 96 and inhibit pull-through of the rod 96 from the plate 106. In one embodiment, the vehicle has a door or panel that is accessible from the interior of the vehicle that may be opened to access the nut 108 for loosening the nut 108 and disconnecting the rod 96 from the mount 104 to facilitate removal of the motor 50 from the wheel hub 16 such as for servicing of the drive assembly 10.

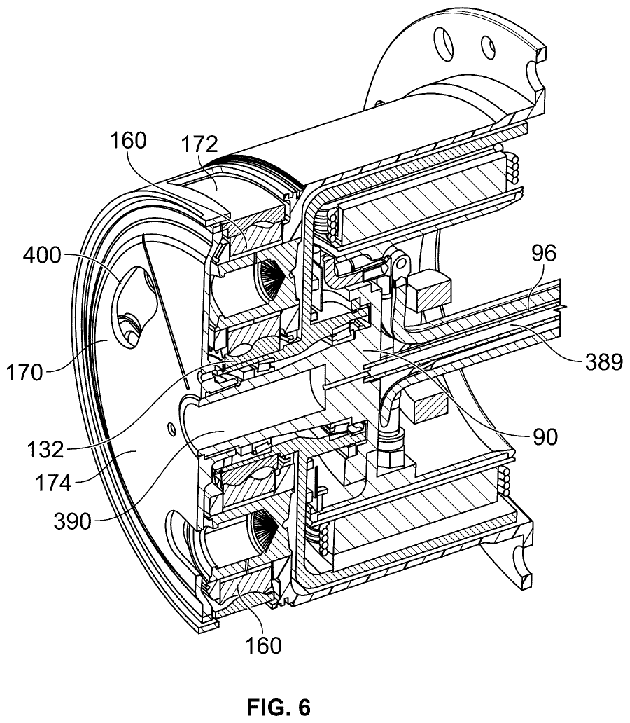

Regarding FIG. 6, the rod 96 is hollow and includes an interior or through opening 389 that opens to a passageway 391 of the stator sleeve 90. The passageway 391 connects the through opening 389 with a central bore 390 of the stator sleeve 90. The through opening 389 operates as a vent for air in a compartment 393 (see FIG. 4) of the drive assembly 10 containing the planetary gear assembly 56. Venting the air in the compartment 393 avoids air pressure build-up and protects seals of the drive assembly 10 from damage.

Regarding FIG. 5, the rotor 54 includes a rotor body 120 with magnets 122 that magnetically interact with one or more coils 124 of the stator 52. The magnets 122 may be permanent magnets and the coils 124 may be copper windings. The stator 52 includes a lamination stack 125 having a sleeve portion 127 fixed to the cooling jacket 234 and walls 128 extending radially from the sleeve portion 127. The lamination stack 125 is made of many thin sheets of a ferro-magnetic material having the shape of the cross-section of the lamination stack 125 that are glued or welded together. The coils 124 loop around the walls 127 and are coated with resin. The coils 124 include motor end windings and the copper windings of the coils 124 are connected at the motor end windings to an inverter of the motor 50 via harness 80. The copper windings of the coils 124 may be distributed or concentrated.

When the coils 124 are energized, the magnetic interaction between the magnets 122 and the coils 124 causes a torque that results in rotation of the rotor body 120 and a rotor drive portion, such as a tubular wall portion 130, having a sun gear 132 of the planetary gear assembly 56 mounted thereto. The tubular wall portion 130 and sun gear 132 have a non-rotatable connection, such as a spline connection 134, therebetween to rotationally fix the sun gear 132 against rotation relative to the tubular wall portion 130. The spline connection 134 includes meshed splines of the rotor body 54 and the sun gear 132 that permit the sun gear 132 to float radially a predetermined distance and find the best engagement with planet gears 160 of the planetary gear assembly 56 during operation of the drive assembly 10. The rotor 54 includes a snap ring 331 (see FIG. 5) that permits the sun gear 132 to float radially while keeping the sun gear 132 from shifting in outboard direction 110. The sun gear 132 is inhibited from shifting in an inboard direction by a shoulder 333 (see FIG. 4) of the rotor body 120. In this manner, the snap ring 331 captures the sun gear 132 on the rotor body 120 and maintains engagement between the meshed splines of the rotor body 120 and sun gear 132 at the spline connection 134.

With reference to FIG. 8, the output housing 60 has an outboard gear support portion 140 with outboard and inboard support portions 142, 144 with openings 146, 148 that receive opposite end portions 149, 150 (see FIG. 5) of shafts 152 of the planetary gear assembly 56. Returning to FIG. 5, the planet gears 160 of the planetary gear assembly 56 are rotatably mounted to the shafts 152 via roller bearing assemblies 162. The shafts 152 and planet gears 160 rotatably mounted thereon rotate at the same speed as the output housing 60 because the shafts 152 are carried by the outboard gear support portion 140. In one embodiment, the output housing has a unitary, one-piece construction and is made of a material, such as a metal such as cast ductile iron or a composite material, selected to withstand the forces produced by the motor 50 as well as to resist environmental conditions such as water, debris, and wheel vibrations or impacts.

With continued reference to FIG. 5, the planetary gear assembly 56 includes a ring gear 170 which, in one embodiment, has a two-part construction with a ring portion 172 and a plate portion 174 that are connected together such as via a weld. The plate portion 174 has a non-rotatable connection 175 with the stator sleeve 90. In one embodiment, the non-rotatable connection 175 includes a press-fit connection 180 to center the ring gear 170 and a spline connection 182 to inhibit turning of the ring gear 170 relative to the stator sleeve 90. The spline connection 182 includes radially inner splines 183 of a sleeve 177 of the plate portion 174 and radially outer splines 185 (see FIG. 7) of a tubular wall 184 of the stator sleeve 90.

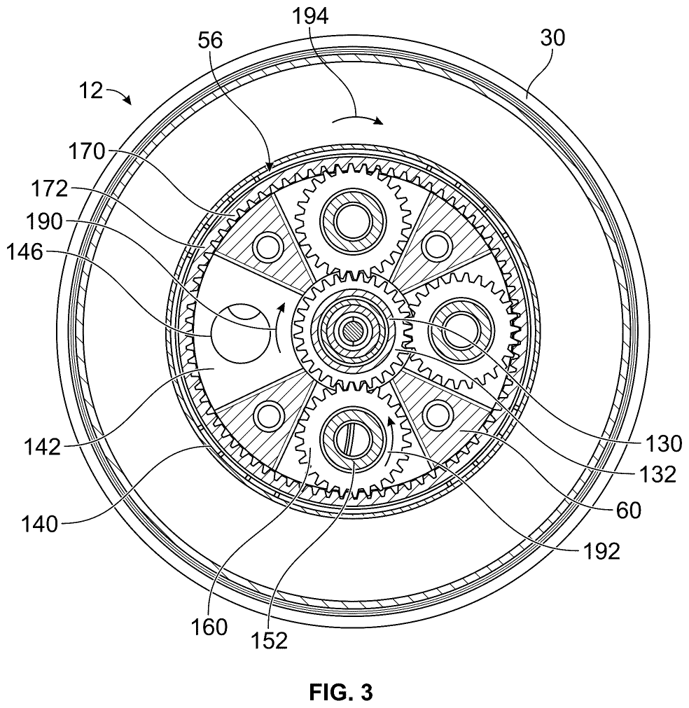

Regarding FIG. 3, the planetary gear assembly 56 is shown with one of the planet gears 160 removed to show the opening 146 in the outboard support portion 142 of the outboard housing 60. Upon energization of the coils 124 of the stator 52, the sun gear 132 turns in direction 190 with the tubular wall portion 130 of the rotor body 120. The turning of the sun gear 132 in direction 190 causes the planet gears 160 to turn in an opposite direction 192 and causes the planet gears 160 to move in direction 194 around the ring portion 172 of the ring gear 170. Because the planet gears 160 are supported on the shafts 152 that are mounted to the output housing 60, the output housing 60 also rotates in direction 194. The rotation of the output housing 60 in direction 194 causes corresponding rotation of the wheel hub 16 and rim assembly 12 secured thereto and propels the vehicle. The drive assembly 10 may be operated in a reverse direction with the motor 50 turning the tubular wall portion 130 of the rotor body 120 and the sun gear 132 in a counter-clockwise direction opposite the direction 190, the planet gears 160 rotating in a clockwise direction opposite the direction 192, and the output housing 60 rotating in a counter-clockwise direction opposite the direction 194. The sun gear 132, planet gears 160, and ring gear 170 all have helical teeth which reduces the operating noise from the drive assembly 10.

With reference to FIG. 7, the harness 80 includes electrical conduits, such as cables 200, 202, 204, 206. The electrical cables 200, 202, 204 have end portions 207, 208, 210 that extend through an upper, radial opening 212 of a sleeve portion 214 of the stator sleeve 90. The interior of the sleeve portion 214 includes the splines 283 that engage the splines 282 (see FIG. 2) of the spindle 18.

As shown in FIG. 7, the cable 206 extends through a lower, radial opening 216 of the stator sleeve 90 that has an end portion 218 for being connected to a grounding point on the stator 52. The harness 80 further includes coolant conduits such as hoses 220, 222 that receive cooled coolant in direction 224 and return heated coolant in direction 226 after absorbing heat from the stator 52.

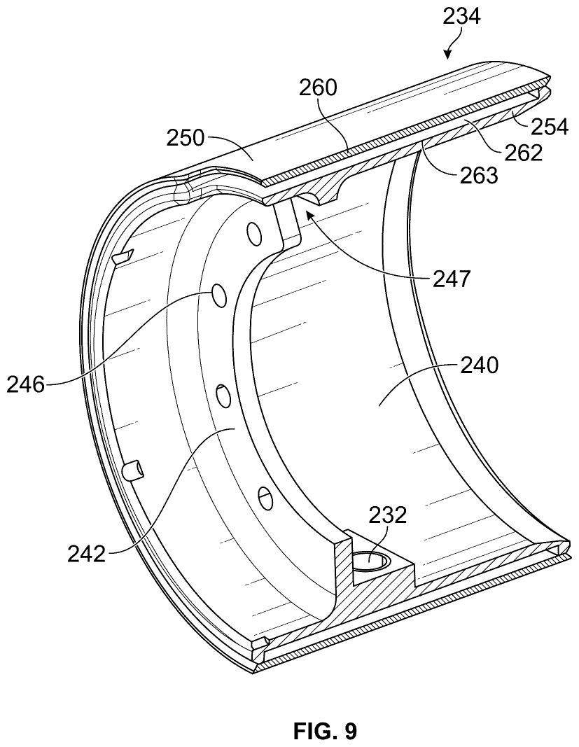

Regarding FIGS. 4, 7, and 9, the hoses 220, 222 have fittings 230 that connect to openings 232 of a cooling jacket 234 of the stator 52. The cooling jacket 234 includes an inner support 240 with a flange 242 for being secured to the flange 244 (see FIG. 7) of the spindle sleeve 90 with fasteners that extend through openings 246, 248 of the flanges 242, 244. The flange 242 of the inner support 240 has a gap 247 (see FIG. 9) that aligns with a gap 245 (see FIG. 7) of the flange 244 of the stator sleeve 90 to form an opening 251 (see FIG. 5) for connector cables 249 to extend therethrough. In one embodiment, the stator 52 includes three coils 124 and there are three connector cables 249 that each connect to one of the coils 124. The connector cables 249 are connected at one end thereof to the coils 124 and are releasably connected at the other end thereof to the end portions 207, 208, 210 of the electrical cables 200, 202, 204. In this manner, the electrical cables 200, 202, 204 may be disconnected from the connector cables 249 in the event the harness 80 is to be replaced.

Regarding FIG. 9, the cooling jacket 234 further includes a radially outer sleeve 250 having a spacing 262 from an annular wall portion 254 of the inner support 240. The openings 232 in the inner support 240 permit coolant to flow from the tube 222 (see FIG. 7) into the spacing 262 and, once the coolant has absorbed heat from the cooling jacket 234, to be returned into the hose 220 and directed back to a coolant system of a vehicle. The sleeve 250 has a radially inner surface 260 and the annular wall portion 254 of the inner support 240 has a radially outer surface 263 spaced from the surface 260 to define at least a portion of the spacing 262 therebetween. The surfaces 260, 263 include structures such as protrusions, grooves, channels, or other features that create a tortuous path of the coolant and ensures that the coolant travels around the entirety of the circumference of the cooling jacket 234 before being returned to the tube 220 for return to the coolant system on-board the vehicle. The features of the surfaces 260, 263 also ensure minimal pressure drop and uniform heat rejection across the entire cooling jacket 234.

Regarding FIG. 4, the brake rotor 66 has a mounting portion 270 connected to the wheel hub mounting flange 26 of the wheel hub 16 and a spacer portion 272 extending an inboard direction from the mounting portion 270 to the disc portion 64. The mounting portion 270 may be secured to the wheel mounting flange 26 such as by using bolts that are driven in an outboard direction through openings of the mounting portion 270 and into openings of the wheel hub 16. To keep the wheel hub 16 rotatably secured to the spindle 18, the spindle lock nut 22 engages threads 280 of the spindle 18 that are inboard of the splines 282 of the spindle 18. In this manner, the sleeve portion 214 of the stator sleeve 90 has an inboard surface 286 (see FIG. 7) that abuts an outboard shoulder 284 (see FIG. 4) of the spindle 18 adjacent the spindle lock nut 22 once stator sleeve 90 is fit onto the outboard end of the spindle 18 and the rod 96 is secured to the plate 106 with the nut 108. In one embodiment, the spindle lock nut 22 is sandwiched between the sleeve portion 214 of the stator sleeve 90 and the cone of the outboard bearing assembly 20A. The spindle lock nut 22 clamps the cones of the bearing assemblies 20A, 20B against an inboard shoulder 288 of the spindle 18. In one embodiment, the bearings 20A, 20B each utilize frustoconical roller bearings that are rotatable around a cone and a cup of the bearings 20A, 20B.

Regarding FIG. 5, the motor 50 includes a motor position sensor 300 for detecting the position of the rotor 54 relative to the stator 52. The position sensor 300 includes a sensor ring 302 mounted to the rotor body 120 and rotatable therewith and a printed circuit board (PCB) 304 having an inductive resolver 305. The inductive resolver 305 includes an excitation coil for generating an alternating magnetic field which induces eddy currents in the sensor ring 302 which create an opposing field reflected back to the receiver coils of the inductive resolver 305. The inductive resolver 305 demodulates the reflected signal and the signals are converted to a rotary angle of the sensor ring 302 and rotor body 120. The sensor ring 302 has alternating windows 306 and spokes 308 around the sensor ring 302 such that rotation of the rotor body 120 causes rotation of the sensor ring 302 and causes alternating windows 306 and spokes 308 to be positioned adjacent the excitation and feedback coils of the inductive resolver 305.

With continued reference to FIG. 5, the drive assembly 10 includes an outboard bearing assembly 310 and inboard bearing assembly 312 to rotatably support the rotor body 120 on the stator sleeve 90. The drive assembly 10 includes a lock nut 311 engaged with threads of the tubular wall 184 to resist movement of the outboard bearing assembly 310 in outboard direction 110. Further, the lock nut 311 is tightened down during assembly to apply a predetermined axial preload on the bearings 310, 312 to minimize clearances.

The spindle sleeve 90 has a shoulder 316 that abuts the inboard bearing assembly 312 and inhibits movement of the inboard bearing assembly 312 in inboard direction 111. The rotor body 120 has a portion, such as a collar 318, that overlaps the outboard and inboard bearing assemblies 310, 312 along an axis parallel to a central rotational axis 319 of the motor 50. The overlapping rotor body collar 318 and outboard and inboard bearing assemblies 310, 312 inhibit movement of the rotor body 120 along the central rotational axis 319 of the motor 50 and keep the rotor body 120 in a predetermined axial position along the spindle sleeve 90.

The stator sleeve 90 has a grounding ring 315 to protect the bearing assemblies 310, 312 from electrical currents from the variable frequency drive of the motor 50. The grounding ring 315 is pressed into the stator sleeve 90 and has carbon fiber brushes that contact the rotor body 120. The grounding ring 315 permits any electric currents in the rotor body 120 to flow to the stator sleeve 90 via the grounding ring 315 rather than via the bearing assemblies 310, 312.

The drive assembly 10 further includes an outboard seal 320 with a sealing member 321, such as a lip seal, mounted to a radially inner surface of the tubular wall portion 130 of the rotor body 120 and rotatable therewith. The sealing member 321 engages a running surface 324 of the ring gear 170 as the sealing member 321 rotates relative to the stator sleeve 90. The motor 50 further includes an inboard seal 330 having a sealing member 332 mounted to and rotatable with the rotor body 120. The sealing member 332 engages a radially running surface 334 of the stator sleeve 90 as the sealing member 332 rotates relative to the stator sleeve 90. The outboard and inboard seals 320, 330 operate to keep oil and debris away from the outboard and inboard bearing assemblies 310, 312 and keep grease within the outboard and inboard bearing assemblies 310, 312. The outboard and inboard seal 320, 330 may each include a resilient member, such as a spring (e.g., a garter spring), to keep the sealing members 321, 332 engaged with the running surfaces 324, 334.

Regarding FIG. 5, the output housing 60 and the rotor body 120 have a seal 340 therebetween to limit oil from traveling inboard from the planetary gear assembly 56. In one embodiment, the seal 340 includes a sealing member 342 mounted to the inboard support portion 144 of the output housing 60 and rotatable therewith. The sealing member 342 engages a running surface 344 of the rotor body 120 as the output housing 60 and rotor body 120 rotate at different speeds. The seal 340 may include a resilient member, such as a spring, to keep the sealing member 342 engaged with the running surface 344.

Regarding FIG. 5, the drive assembly 10 has a cover 360 that is releasably connected to the output housing 60 via clips 362. The clips 362 are removable to disconnect the cover 360 from the output housing 60 and permit servicing of the planetary gear assembly 56. The clips 362 extend in openings 364 and grooves 366 of the cover 360 and the output housing 60. The drive assembly 10 includes a seal, such as an o-ring 368, to resist oil from leaking out between the cover 360 and the output housing 60.

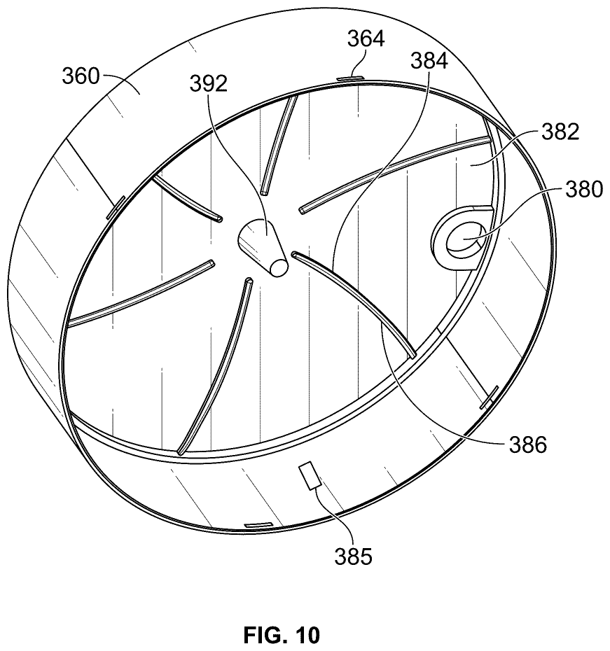

Regarding FIG. 5, the cover 360 covers the outboard gear support portion 140 (see FIG. 8) of the output housing 60 and the planetary gear assembly 56 and provides a compartment or interior 370 to contain oil for lubricating the planetary gear assembly 56. The drive assembly 10 has a self-contained oil reservoir provided by the interior 370 such that a remote, vehicle-mounted oil sump or reservoir is not required for the drive assembly 10. Instead, the cover 360 has a fill opening 380 (see FIG. 10) in an outboard wall 382 that permits an installer to fill the interior 370 with a predetermined level of oil during installation of the drive assembly 10.

To encourage an even distribution of oil on the components of the planetary gear assembly 56, the cover 360 (see FIG. 10) includes one or more features, such as one or more vanes 384, that travel through the oil at the lower end of the interior 370 when the output housing 60 begins turning. The vanes 384 have surfaces 386 that direct the oil radially inward toward a central protrusion, such as a boss 392, of the cover 360. The cover 360 may also include one or more structures, such as one or more protrusions 385, configured to lift oil from the bottom of the interior of the cover 360 and drop the oil onto the top of the ring gear 170.

Some of the oil reaches the boss 392 and some of the oil is flung or otherwise directed into openings 400 (see FIG. 6) of the ring gear plate portion 174 to lubricate the ring gear ring portion 172, planet gears 160, and sun gear 132. The boss 392 protrudes into the central bore 390 (see FIG. 5) of the stator sleeve 90 and has a frustoconical outer surface to redirect oil that travels through a gap 394 between the cover 360 and ring gear plate portion 174 into the central bore 390. The central bore 390 operates as a reservoir to keep a volume of lubricant at the center of rotation of the drive assembly 10 that may flow radially outward and ensures even coverage of the planetary gear assembly 56 during operation of the drive assembly 10.

Regarding FIG. 5, the oil in the interior 370 is generally urged radially outward due to the rotation of the output housing 60 and the rotor body 120, which rotate at different speeds. The shafts 152 that rotatably support the planet gears 160 are hollow and include bores 410 that receive oil flowing in the planetary gear assembly 56 during operation of the drive assembly 10. The shafts 152 have passageways 412 that permit oil in the bores 410 to flow radially outward into the roller bearing assemblies 162 of the planet gears 160 to lubricate the roller bearing assemblies 162. Regarding FIG. 8, the output housing 60 likewise has openings 416, 418 formed therein that permit oil to flow therethrough and contact the gears of the planetary gear assembly 56.

Regarding FIG. 8, the flange 62 of the output housing 60 has stud holes 430 to receive the studs 24 of the wheel hub 16. The flange 62 further includes smaller, mounting fastener holes 432 that receive mounting fasteners for connecting the output housing 60 to the wheel mounting flange 26 of the wheel hub 16. In one embodiment, the holes 432 are countersink clearance holes with countersinks at an outboard surface 62A of the flange 62. The holes 432 receive the mounting fasteners such that heads of the mounting fasteners are flush with the outboard surface 62A. In this manner, the mounting fasteners of the holes 432 provide a connection between the drive assembly 10 and the wheel hub 16 that is independent of the studs 24 of the wheel hub 16. Stated differently, the output housing 60 and the other components of the drive assembly 10 can be secured to the wheel hub 16 and spindle 18 prior to the rim assembly 12 being secured to the wheel mounting flange 26 and remain secured to the drive assembly 10 when the rim assembly 12 is removed from the wheel mounting flange 26.

The output housing 60 is mounted to the wheel hub 16 by positioning the output housing 60 so that the studs 24 extend in the stud holes 430, advancing the output housing 60 along the studs 24 and against the wheel mounting flange 26, advancing the mounting fasteners into the mounting fastener holes 432, engaging nuts with the shanks of the mounting fasteners, positioning the rim assembly 12 onto the studs 24, and engaging lug nuts 42 with the studs 24 to fix the rim assembly 12 to the wheel mounting flange 26. Tightening down the lug nuts 42 on the studs 24 causes the flange 62 of the output housing 60 to be clamped between outboard and inboard flange portions 36, 40 of the rim assembly 12 and the wheel mounting flange 26 of the wheel hub 16.

With reference to FIG. 2, the outboard and inboard flange portions 36, 40 of the rim assembly 12 have inner diameters that are larger than an outer diameter of an annular wall portion 431 (see FIG. 8) of the output housing 60 and the cover 360 to permit the rim assembly 12 and tires thereon to be disconnected and removed from the wheel hub 16 while the output housing 60 remains secured to the wheel hub 16. The annular wall portion 431 has a smaller outer diameter than a pilot 433 of the output housing 60 to provide additional clearance for the rim assembly 12 along a majority of the length of the output housing 60. The pilot 431 helps center the rim assembly 12 on the output housing 60 as part of connecting the rim assembly 12 to the wheel hub 16.

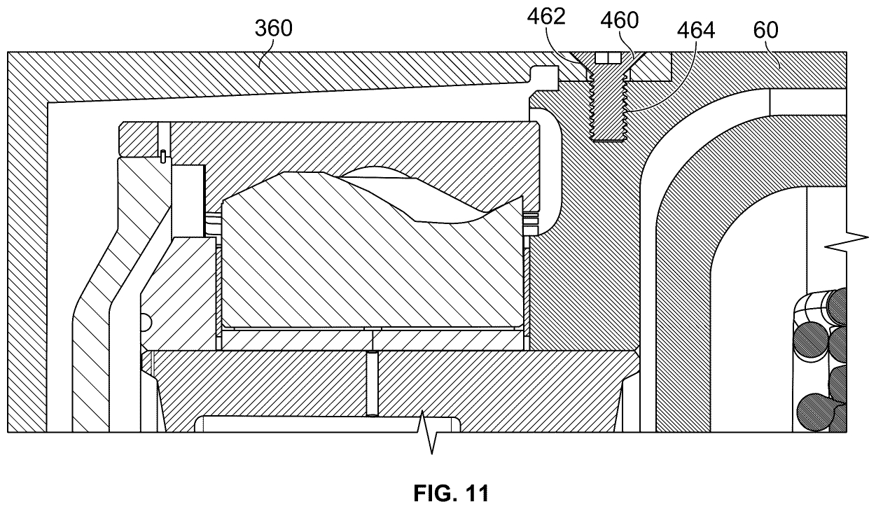

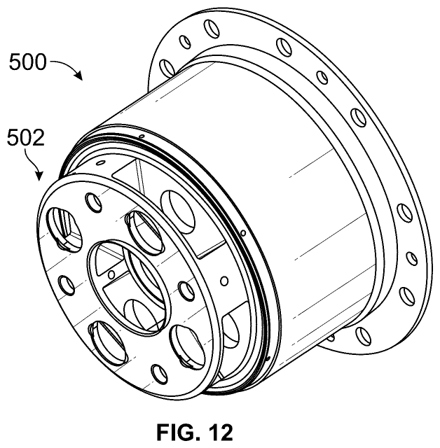

Regarding FIG. 11, in one embodiment, the cover 360 may be connected to the output housing 60 via fasteners 460 that extend through openings 462 of the cover 360 engaged in threaded openings 464 of the output housing 60.

Regarding FIG. 12, another output housing 500 is provided that is similar in many respects to the output housing 60 discussed above. One difference is that the output housing 500 includes an outboard gear support portion 502 that lacks an outer ring 67 (see FIG. 8) for supporting the interior of the cover 360.

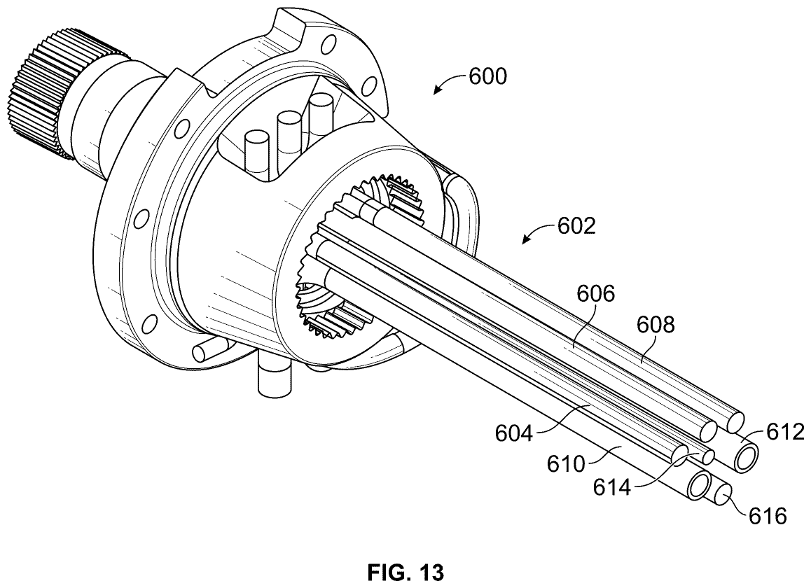

Regarding FIG. 13, another stator sleeve 600 and harness 602 are provided that are similar to the stator sleeve 90 and harness 80 discussed above. The harness 602 includes cables 604, 606, 608 to provide three-phase electrical power to the motor 50. The harness 602 includes hoses 610, 612 for facilitating a flow of coolant between the motor 50 and a coolant system onboard the associated vehicle. The harness 602 further includes a ground cable 614 and a communication cable 616. The communication cable 616 is connected to the PCB 304 and provides a communication path for rotor position detected by the inductive sensor 305. The communication cable 616 also provides a communication path for temperatures of the stator coils 124 measured by the temperature sensors 124A. The PCB 304 operates as an interface between the temperature sensors 124A and the communication cable 616.

In one embodiment, the drive assembly 10 may operate as a generator to generate electrical power from rotation of the wheel hub 16. For example, the motor 50 may be operated to provide regenerative braking and generate electrical power by applying a brake torque to resist turning of the wheel hub 16. The drive assembly 10 may provide the electrical power to a component of the vehicle, such as charging a battery of a vehicle.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims.

What is claimed is:

1. An in-wheel drive assembly comprising:
a stator configured to form a non-rotatable connection with a spindle of a vehicle and be positioned outboard of the spindle;
a stator retainer configured to extend in an interior of the spindle and inhibit movement of the stator in an outboard direction relative to the spindle;
a rotor rotatably supported by the stator;
an output housing to be connected to a wheel hub; and
a planetary gear assembly operatively connecting the rotor and the output housing, the planetary gear assembly configured to cause rotation of the output housing and wheel hub connected thereto in response to rotation of the rotor.

2. The in-wheel drive assembly of claim 1 wherein the stator has an inboard end portion configured to permit the stator to be advanced in an inboard direction onto the spindle and form the non-rotatable connection with the spindle.

3. The in-wheel drive assembly of claim 1 wherein the stator comprises splines configured to form the non-rotatable connection with splines of the spindle.

4. The in-wheel drive assembly of claim 1 wherein the stator comprises a sleeve for extending about an outboard end portion of the spindle; and
wherein the stator retainer is configured to be spaced radially inward of the sleeve and the outboard end portion of the spindle with the stator non-rotatably connected to the spindle.

5. The in-wheel drive assembly of claim 1 wherein the output housing extends about the rotor; and
wherein the planetary gear assembly causes the output housing to rotate around the rotor in response to rotation of the rotor.

6. The in-wheel drive assembly of claim 1 wherein the planetary gear assembly comprises planetary gears rotatably mounted to the output housing, the output housing and planetary gears configured to rotate together in response to the planetary gear assembly causing rotation of the output housing.

7. The in-wheel drive assembly of claim 1 wherein the output housing is outboard of the rotor.

8. The in-wheel drive assembly of claim 1 wherein the stator retainer is configured to extend in the interior of the spindle spaced from the spindle and connect to a mount of the vehicle inboard of the spindle.

9. The in-wheel drive assembly of claim 1 wherein the stator retainer includes an elongate member having an end portion configured to releasably connect to a mount of the vehicle.

10. The in-wheel drive assembly of claim 9 wherein the stator and the elongate member have a releasable connection therebetween.

11. The in-wheel drive assembly of claim 9 wherein the end portion of the elongate member is sized to extend in an opening of the mount; and
the stator retainer further comprising a locking member configured to secure the elongate member to the mount with the end portion of the elongate member extending in the opening of the mount.

12. The in-wheel drive assembly of claim 1 wherein the stator includes a sleeve portion having radially inner splines configured to engage radially outer splines of the spindle and form the non-rotatable connection between the stator and the spindle.

13. The in-wheel drive assembly of claim 1 wherein the planetary gear assembly comprises planetary gears and shafts rotatably supporting the planetary gears, the shafts each having opposite end portions; and
wherein the output housing includes support portions that support the opposite end portions of the shafts.

14. The in-wheel drive assembly of claim 1 wherein the planetary gear assembly includes a sun gear mounted to the rotor, the in-wheel drive assembly further comprising a pair of bearing assemblies rotatably connecting the rotor and the stator, the bearing assemblies spaced apart from one another along an axis of rotation of the rotor.

15. The in-wheel drive assembly of claim 1 wherein the stator comprises a stator sleeve configured to form the non-rotatable connection with the spindle and a stator support connected to the stator sleeve, the stator support having one or more coils thereon; and
wherein the rotor is rotatably mounted to the stator sleeve.

16. The in-wheel drive assembly of claim 15 wherein the planetary gear assembly comprises a ring gear non-rotatably connected to the stator sleeve.

17. The in-wheel drive assembly of claim 1 wherein the stator comprises a stator sleeve;
a cover to be connected to the output housing and rotate therewith, the cover having an opening to receive lubricant; and
wherein the stator sleeve includes a lubricant reservoir.

18. The in-wheel drive assembly of claim 17 wherein the cover includes vanes to direct lubricant radially inward toward the lubricant reservoir of the stator sleeve upon rotation of the cover.

19. The in-wheel drive assembly of claim 1 wherein the planetary gear assembly includes a ring gear non-rotatably connected to the stator, the in-wheel drive assembly further comprising:
a first seal between the rotor and the ring gear;
a second seal between the rotor and the stator; and
a third seal between the rotor and the output housing.

20. The in-wheel drive assembly of claim 1 further comprising an electrical grounding ring between the rotor and the stator.

21. The in-wheel drive assembly of claim 1 further comprising a rotor position sensor comprising an inductive resolver.

22. The in-wheel drive assembly of claim 1 wherein the stator retainer includes an elongate member to extend in an interior of the spindle, the elongate member having a through opening in communication with an interior of the planetary gear assembly to vent air from the interior of the planetary gear assembly.

23. The in-wheel drive assembly of claim 1 further comprising a harness including electrical cables and coolant conduits to extend in the interior of the spindle;
wherein the stator includes a cooling jacket and one or more coils; and
wherein the stator has at least one opening sized to permit the electrical cables and coolant conduits to extend from the interior of the spindle to connections with the cooling jacket and the one or more coils.
